(19) United States
(12) Patent Application Publication
(10) Pub. No.: US 2003/0046871 A1
(43) Pub. Date: Mar. 13, 2003

(54) Safety-type viewing window assembly for protective housings and protective doors of material-processing machines

(75) Inventors: Steffen Walter, Rodgau-Jugesheim (DE); Dieter Asmussen, Ahrensburg (DE); Martin Schorning, Bielefeld (DE)

Correspondence Address: COHEN, PONTANI, LIEBERMAN & PAVANE, 551 FIFTH AVENUE, SUITE 1210, NEW YORK, NY, 10176, US

(73) Assignee: Hema Maschinen-und Apparateschutz GmbH

(21) Appl. No.: 10/238,455

(22) Filed: Sep. 10, 2002

(30) Foreign Application Priority Data
Sep. 10, 2001 (DE) 10144458.3

(51) Int. Cl. E06B 7/28

(52) U.S. Cl. 49/171

(57) ABSTRACT

A safety-type viewing window assembly for protective housings and protective doors of material-processing machines, such as grinding or metal-cutting machines. The assembly includes a fixed, transparent glass pane coupled along its periphery to a fixed, transparent, puncture-proof or unbreakable protective pane made, for instance of polycarbonate. The glass pane is on the side of the assembly toward the machine and the protective pane is on the side toward the user. The glass pane has a circular opening which is covered by a circular, transparent, rotatable window made of transparent glass which is coupled, on its side facing toward the protective pane, to a rotary drive mechanism. The diameter of the rotatable window is slightly less than the diameter of the opening in the glass pane. The rotatable window is disposed inside the opening in the glass pane, and the gap between the periphery of the rotatable window and the opening in the glass pane is sealed. The surfaces of the rotatable window and of the glass pane, pointing away from the protective pane, are substantially aligned with one another. The rotary drive mechanism is disposed substantially entirely inside the fixed window assembly.

### FIELD OF THE INVENTION

The invention relates to a safety-type viewing window assembly having a fixed, transparent glass pane coupled to a protective plastic pane, with the glass pane and protective plastic pane having circular openings therein and a rotatable glass window driven by a rotary drive mechanism covering the opening in the glass pane. In particular, the invention is directed to such a viewing window in which a smaller opening in the protective pane is needed, blocking of the user's view is reduced, and protrusion of window components beyond the assembly is minimized.

### BACKGROUND OF THE INVENTION

Such known safety-type viewing window assemblies are resistant to the damaging influence of cooling fluid, chips of material or the like because of the glass pane on the machine side, and protective of persons on the user side by means of the puncture-proof or unbreakable plastic protective pane. The protective pane can, if needed, have a transparent surface or transparent additional layer which is an abrasion- or scratch-resistant coating or protective film on the side toward the user, or a glass windowpane, with an anti-splintering protective film glued to it, that is glued to the user side. The protective pane can also have a transparent liquid and/or gas-tight protective film or coating.

It is known for the glass and protective panes of the safety-type viewing window assembly to be provided with coaxial openings of equal diameter. A self-contained, elongated, cylindrical, window assembly is inserted into this opening. The assembly includes a transparent (i.e. clear-view) rotatable window coupled to a rotary drive mechanism for rotatable the window at a high speed about its axis. Such an arrangement is described in German Patent Publication DE 35 32 362 A1. The rotatable window, by its rotation, assures continuously satisfactory visibility by slinging off, with centrifugal force, any debris that contacts it. This window assembly has parts on the machine and user sides that protrude from the surfaces of the window assembly. For many applications, such as in the field of sliding doors, such protruding parts are undesirable, at least on the machine side. Moreover, it is disadvantageous that on the user side the protective pane has to have a large opening whose diameter is approximately equivalent to that of the rotatable window, because this severely compromises its structural integrity and hence makes it weaker and, thus, less safe.

It is also known, in a safety window assembly, not to provide any openings in its glass and protective panes, and instead, on the machine side, to glue a short, cylindrical window assembly, with a clear-view rotatable window that is rotatable at high speed and with a rotary drive mechanism, to the glass pane, such as that described in European Patent Publication EP 0 869 055 A2. The substantial disadvantage of this assembly is that here the entire window assembly protrudes from the machine side, making it a hindrance.

### SUMMARY OF THE INVENTION

One object of the present invention is to provide an improved safety-type viewing window of the type described above.

Another object of the present invention is to provide a safety-type viewing window in which a smaller opening in the protective pane is needed.

A further object of the present invention is to provide a safety-type viewing window in which blocking of the user's view is reduced.

Yet another object of the present invention is to provide a safety-type viewing window in which protrusion of window components beyond the window assembly is minimized.

These and other objects are attained in accordance with one aspect of the present invention directed to a safety-type viewing window assembly that includes a fixed, transparent glass pane coupled along its periphery to a fixed, transparent, protective pane. The glass pane has a circular opening with a circular, rotatable window made of transparent glass disposed therein which is coupled to a rotary drive mechanism. The diameter of the rotatable window is slightly less than the diameter of the opening in the glass pane. The gap between the periphery of the rotatable window and the opening in the glass pane is sealed. The surfaces of the rotatable window and of the glass pane, pointing away from the protective pane, are substantially aligned with one another. The rotary drive mechanism is disposed substantially entirely inside the window assembly.

### BRIEF DESCRIPTION OF THE DRAWINGS

FIG. 1 shows a schematic sectional view of a first embodiment of a window assembly in accordance with the present invention, with a rotary drive mechanism being disposed coaxially to the rotatable window;

FIG. 2 shows a schematic plan view of the window assembly of FIG. 1;

FIG. 3 shows the window assembly of FIG. 1 in a fragmentary section through its rotary drive mechanism;

FIG. 4 is a schematic fragmentary sectional view of a second embodiment of window assembly in accordance with the present invention, with a rotary drive mechanism being laterally shifted relative to the rotatable window;

FIG. 5 shows the window assembly of FIG. 4 in a schematic plan view, with the rotary drive mechanism being shifted to the periphery of the window assembly;

FIG. 6 shows the window assembly of FIG. 4 in a schematic plan view, with the rotary drive mechanism being shifted to the periphery of the labyrinth seal; and

FIG. 7 is a fragmentary section similar to FIG. 3 showing a third embodiment having an hydraulic or pneumatic rotary drive mechanism.

### DETAILED DESCRIPTION OF THE DRAWINGS

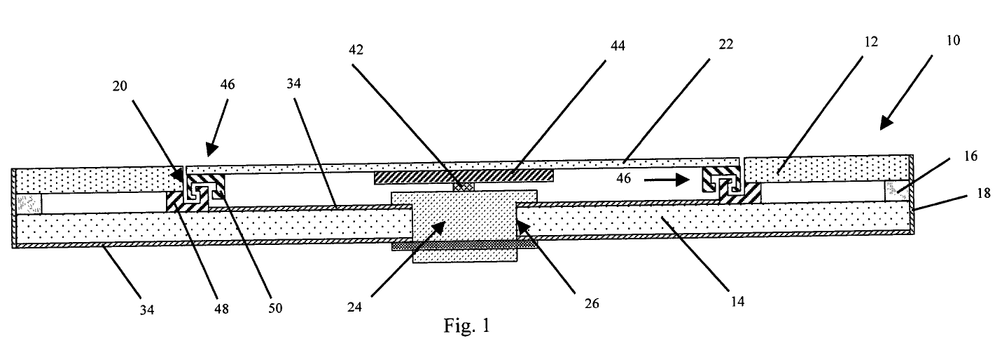

In the first embodiment shown in FIGS. 1-3, a window assembly 10 comprises a transparent glass pane 12 and a puncture-proof or unbreakable, transparent protective pane 14, kept spaced apart from the glass pane 12 and parallel thereto by a connection 16 positioned around its periphery. The protective pane is made, for instance, of polycarbonate. Peripherally, the assembly is surrounded by a frame 18 or a seal. When the window assembly is ultimately installed in a protective housing or a protective door of a material-processing machine, for example, the glass pane 12 should be disposed on the machine side, and the protective pane 14, which serves to protect persons using the machine, should be disposed on the user side.

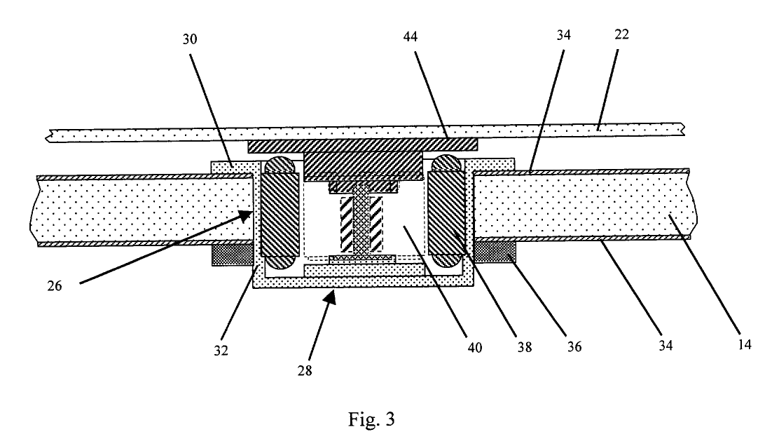

A circular opening 20 is formed in the glass pane 12, into which a circular rotatable window 22 of transparent glass is inserted with relatively little play in such a way that the glass surfaces, facing toward the machine, of the glass pane 12 and of the rotatable window 22 are approximately in the same plane. The rotatable window 22 is coupled, via a connection disk 44 secured to it and via a drive member 42, such as a drive shaft, that engages the connection disk, to a rotary drive mechanism 24, which is disposed coaxially to the rotatable window and which is an electric motor that is located, as shown in FIG. 3, in a hat-shaped receiving member 28. This receiving member is made of a puncture-proof or unbreakable metal and rests with its wide brim 30 extending annularly over a large surface area on a liquid- and/or gas-tight protective film or coating 34 of the protective pane 14.

The protective film or coating 34 covers at least those faces, oriented toward the interior of the window assembly 10, that can come into contact with liquids and/or gases entering the interior from the machine side. This prevents the structural integrity of the protective pane 14, which protects the user side, from being compromised by damaging liquids and/or gases. As a precaution, the surfaces on the user side of the protective pane 14 are protected accordingly as well by another film or coating 34.

A cup-shaped portion 32 of the receiving member 28 reaches through a circular opening 26 in the protective pane 14 and is screwed on its outer, or user, side to a wide threaded ring 36. This ring rests annularly over a large surface area on the outer liquid and/or gas-tight protective film or coating 34 of the protective pane 14.

The diameter of the opening 26 in the protective pane 14 is small compared to the diameter of the rotatable window 22 or of the opening 20 in the glass pane 12. Thus, the coaxial rotary drive mechanism 24 obstructs the viewing field of the rotatable window 22 only slightly. Since the opening 26 is engaged annularly over a large area by the brim 30 and the threaded ring 36, the protective pane 14 is optimally protected mechanically.

In FIG. 3, a stator 38 of the rotary drive mechanism 24 is located in the receiving member 28. A rotor 40 located in the interior of the stator 38 is rotatably supported, in a manner not shown in detail, on a rotor shaft or axle kept stationary in the receiving member 28 and is connected via the drive member 42 to the connection disk 44 on the rotatable window 22. The gap between the periphery of the rotatable window 22 and the opening 20 in the glass pane 12 is sealed off by a contactless annular seal 46, in the present case a labyrinth seal. The seal 46 comprises one fixed sealing member 48 and one sealing member 50 that is secured, for instance glued, to the inside of the rotatable window 22 and that is rotatable with the rotatable window. The sealing members 48, 50 mesh in labyrinthine fashion with one another. The sealing member 48 is retained between the glass pane 12 and the protective pane 14.

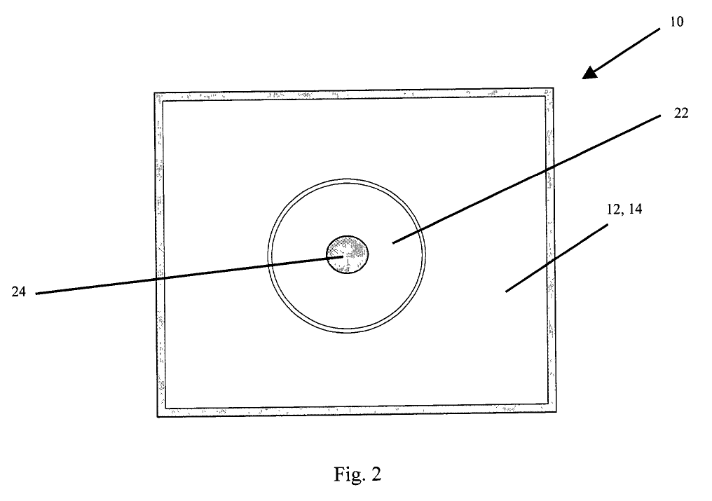

It is readily apparent from FIG. 2 that the large-area viewing field of the window assembly and of the rotatable window 22 is only insignificantly blocked by the coaxially disposed rotary drive mechanism 24.

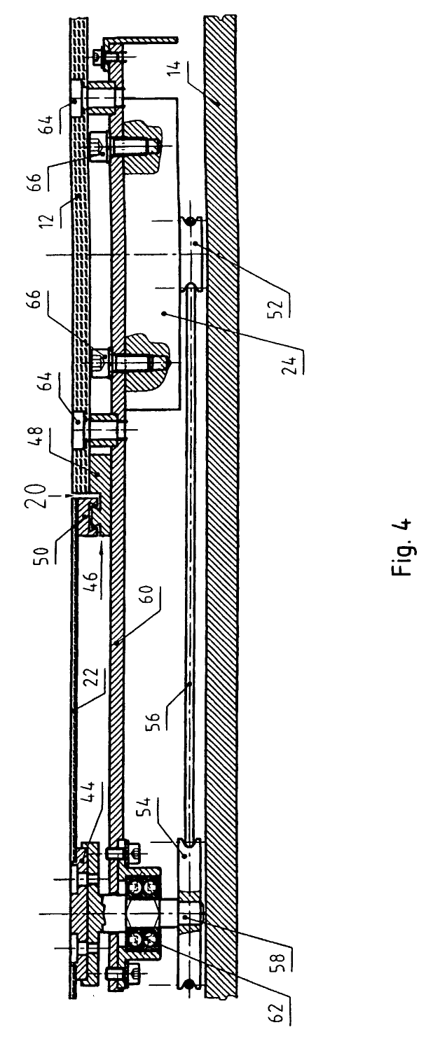

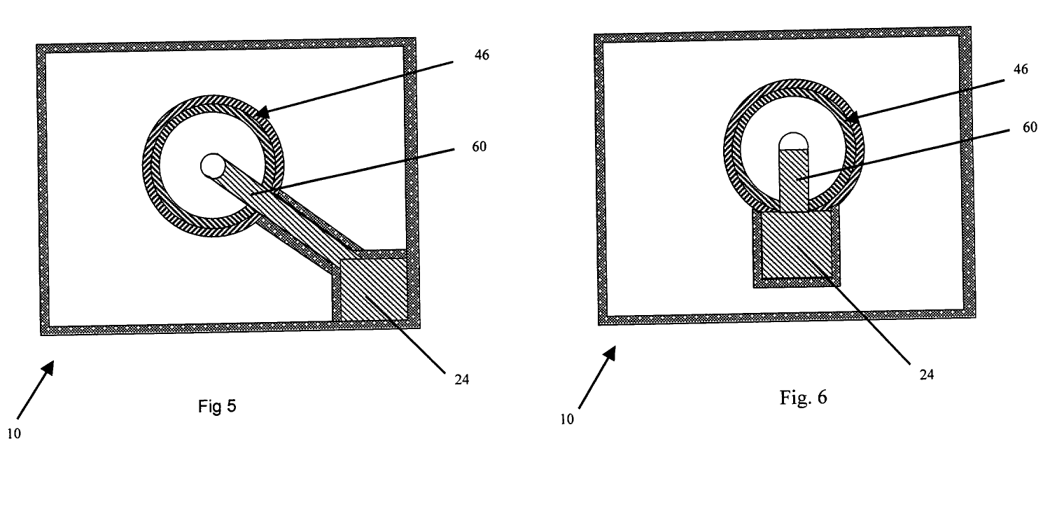

The second embodiment, shown in FIGS. 4-6, differs from the first embodiment of FIGS. 1-3 essentially in that the rotary drive mechanism 24 is shifted laterally out of the viewing region of the rotatable window 22 and is coupled to the rotatable window 22 via a transmission mechanism, such as a gear. This lateral shift can be made to the periphery of the window assembly 10, as shown in FIG. 5, or to the periphery of the seal 46, such as a labyrinth seal, as shown in FIG. 6.

In FIG. 4, the rotary drive mechanism 24, laterally shifted and disposed entirely in the interior of the window assembly 10, is connected to a driving wheel 52, such as a pulley, as a first gear part. A driven wheel 54, such as a pulley, that is coaxial to the rotatable window 22 is located as a second gear part in the same plane as the driving wheel 52 and is coupled to it via a force transmission member 56, such as a drive belt, as the third gear part. The driven wheel 54 is coupled via a connection shaft 58 to the connection disk 44 on the rotatable window 22. The connection shaft 58 is retained in the interior of the window assembly 10 via a bearing 62, on a retaining arm 60 that is narrow in the direction of view of the user (such as the view of FIG. 5). The retaining arm 60 is secured, via screws 64, to the glass pane 12 outside the viewing field of the rotatable window 22. The rotary drive mechanism 24 is fixed to the retaining arm 60 via screws 66.

In FIGS. 5 and 6, the narrow retaining arm 60 and the force transmission member 56 coincide in the viewing direction of the user, thereby eliminating only a narrow viewing region of the rotatable window 22.

In FIG. 4, the rotatable window 22, as in the first embodiment, is disposed in an opening in the glass pane 12 in such a way that the glass surfaces facing toward the machine are essentially aligned. The fixed sealing member 48 of the seal 46, the latter embodied as in the first embodiment as a labyrinth seal, is secured to the inside of the glass pane 12, for instance being glued there, while the sealing member 50 that can rotate jointly with the rotatable window 22 is secured, for instance glued, to the inside of the rotatable window.

In the second embodiment, the protective pane 14 has no opening whatever. Thus its structural integrity is not significantly compromised anywhere in its entire region. However, it is alternatively possible to turn the rotary drive mechanism 24 upside down compared to FIG. 4, and in a manner not shown to have it protrude through an opening in the protective pane 14 toward the user side. This variant can be useful, for instance, whenever the rotary drive mechanism is relatively large and does not fit into the interior of the window assembly. The protective pane 14 can, as in the first embodiment, have a protective film or coating (not shown).

Electrical and/or hydraulic or pneumatic supply lines can be placed within the interior of the window assembly. The requisite control elements can be disposed outside the viewing field of the rotatable window 22. For instance, as shown in FIGS. 5 and 6, the control elements can be in the region of the laterally shifted rotary drive mechanism 24.

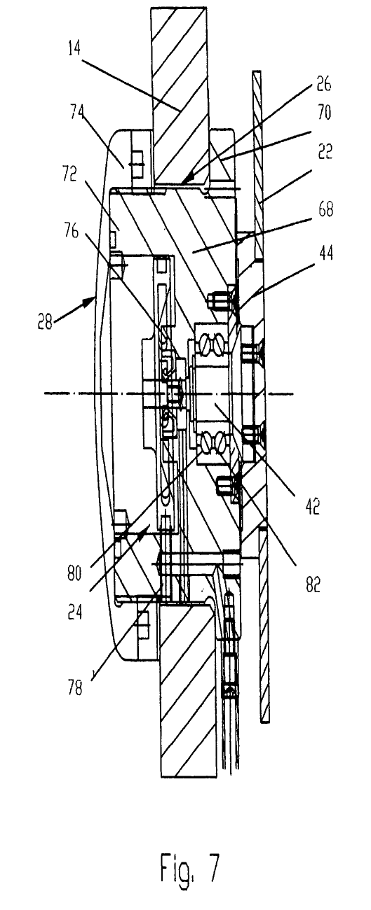

In the embodiment shown in FIG. 7, which is similar to FIG. 3, a body member 68 of a receiving member 28 serves to retain a hydraulic or pneumatic rotary drive mechanism 24. Body member 68 extends, with a male-threaded cylindrical projection 72, slightly through the opening 26 in the protective pane 14. A threaded cap 74 of the receiving member 28 is screwed on the projection 72. Cap 74 is braced over a large surface area on the protective pane 14. The body member 68 rests with a rim 70 over a large area on the inside of the assembly on the protective pane 14.

Inside the projection 72 is a rotatable hydraulic or pneumatic vane or fan wheel 76, connected to a drive member 42, in the form of a drive shaft. Drive member 42 is stepped a single time in its diameter and is connected to the rotatable window 22 via a connection disk 44. The absolute diameter of drive member 42 increases in the direction of the rotatable window 22. In each of the two regions of different diameter, there is a respective bearing 80 and 82. The bearings 80, 82, which become larger in the direction toward the rotatable window 22, are retained on the outside in correspondingly stepped indentations in the body member 68. Associated with the peripheral edge of the vane or fan wheel 76 is a hydraulic or pneumatic nozzle 78, which is retained on the body member 68 and is supplied with drive fluid via a suitable supply line in the interior of the window assembly.

This structural form of FIG. 7 has proved itself well in practical operation, and because of the special way in which the drive shaft is supported, it provides major operating safety, since the two steps of the diameter assure that an impact energy exerted centrally will be distributed over a larger surface area in the receiving member 28.

Various advantages are attained by the present invention in comparison with the prior art. Because of its integral, compact structure, the window assembly of the invention has the substantial advantage of not having any obstructing protruding part on the machine side and of not needing a large opening in the protective pane 14, which would be less safe and structurally weaker. The user side can be completely free of protruding parts as well. This assures versatile use, with great safety in operation.

In practical operation, a contactless seal, such as a labyrinth seal, has proved advantageous. As a result, losses from friction, irritating noise, and wear are avoided. For such a seal, the structure is especially simple, inexpensive and reliable, and is easy to maintain. These sealing elements can be disposed in the interior of the window assembly and outside the gap between the rotatable window and the glass pane. Alternatively, however, a very compact structure is possible, in which the sealing elements are located inside the gap between the rotatable window and the glass pane. Also, the glass surfaces on the machine side of the glass pane and of the rotatable window can be protected in a suitable way, to assure safe long-term operation and continuously good visibility. Furthermore, an embodiment is disclosed providing a very compact structure, in which the hydraulic or pneumatic rotary drive mechanism is not retained at all on the protective pane but, instead, is retained on the rotatable window such as to be acted upon by a hydraulic or pneumatic current ejected from a nozzle on the window assembly. Thus an opening in the protective pane can be omitted entirely. By means of a forced flow of air or gas, from the interior of the window assembly through the contactless seal, such as a labyrinth seal, to the machine side, the viewing conditions are markedly improved, because this prevents the formation of condensate, fogging on the inside, and the invasion of liquids and gases from the machine side. The alternative disposition of the rotary drive can be especially expedient, because a central rotary drive mechanism may be undesirable. It is also possible as a result to preserve an especially wide viewing field in the region of the rotatable window. A structural arrangement as shown in FIG. 7 has proven itself in practical operation, and because of the increasing diameter of the two bearings in the direction of the machine side, it leads to especially high puncture strength with the attendant operating safety.

We claim:

1. A safety-type viewing window assembly comprising:
a transparent glass pane having a circular opening formed therein;
a transparent protective pane coupled substantially in parallel to said glass pane and spaced therefrom to form an interior of the window assembly;
a transparent, rotatable window disposed inside said opening in said glass pane and having a diameter slightly less than the diameter of said opening in said glass pane to form a gap between the periphery of the rotatable window and said opening in the glass pane;
a rotary drive mechanism drivingly coupled to said rotatable window;
a seal positioned to close said gap;
wherein surfaces of said rotatable window and of said glass pane that face away from said protective pane are in substantially planar alignment with one another; and
wherein the rotary drive mechanism is disposed substantially entirely inside the window assembly.

2. The window assembly of claim 1, wherein the rotary drive mechanism comprises an electric motor disposed coaxially relative to the rotatable window (22) and is secured to said protective pane.

3. The window assembly of claim 1, wherein the rotary drive mechanism comprises one of a hydraulic and pneumatic motor disposed coaxially relative to the rotatable window and is secured to one of said protective pane and said rotatable window.

4. The window assembly of claim 1, wherein said protective pane comprises a substantially circular opening which is disposed coaxially relative to said opening in the glass pane and having a diameter that is small compared to the diameter of the opening in the glass pane; and
further comprising a receiving member disposed in said opening in the protective pane and having an interior that points toward said interior of the window assembly, said receiving member being releasably coupled in a sealed manner to the protective pane and comprises a puncture-proof or unbreakable material; and
wherein said receiving member accommodates said rotary drive mechanism therein.

5. The window assembly of claim 4, wherein said receiving member extends through the opening in the protective pane into the interior of the window assembly, said receiving member being shaped in the form of a hat to have a brim extending from a hat body, said brim (30) overlying a surface of the protective pane facing toward the interior of the window assembly, and the hat body extending through the opening in the protective pane and having an exterior end releasably screwed to a threaded ring which overlies a surface area on a surface of the protective pane facing away from the interior of the window assembly.

6. The window assembly of claim 4, wherein said receiving member comprises metal or impact-proof plastic.

7. The window assembly of claim 4, wherein the rotary drive mechanism comprises an electric motor having a radially outer stator disposed in the interior of the receiving member, and a radially inner rotor received within said stator, said rotor being coupled to said rotatable window via a drive element.

8. The window assembly of claim 7, wherein said rotor is supported rotatably on a stationary rotor axle that is retained in the receiving member.

9. The window assembly of claim 1, wherein said rotary drive mechanism comprises a drive member coupled to a central connection disk that is securely connected to the rotatable window.

10. The window assembly of claim 1, wherein the seal between the periphery of the rotatable window and the opening in the glass pane comprises a contactless seal disposed inside the window assembly.

11. The window assembly of claim 10, wherein said seal is a labyrinth seal comprising an annular, fixed sealing member and a rotatable sealing member in contactless sealing position with the fixed sealing member, said rotatable sealing member being coupled to the rotatable window to be driven to rotate jointly therewith.

12. The window assembly of claim 11, further comprising a connection member positioned at the periphery of said glass pane and said protective pane to couple said glass and protective panes in spaced relationship to one another, and a fixed sealing member retained between the glass pane and the protective pane in an area facing said gap.

13. The window assembly of claim 10, wherein the opening in the glass pane, on the inside, has an annular shoulder with a tapering diameter, and wherein said labyrinth seal is located between this shoulder and the rotatable window.

14. The window assembly of claim 13, wherein the labyrinth seal comprises meshing glass profiles of the glass pane and of the rotatable window, or meshing metal or plastic parts seated on the glass pane and the rotatable window.

15. The window assembly of claim 11, wherein at least all the regions of the protective pane that are connected, inside the window assembly, to the labyrinth seal are covered by a liquid- and/or gas-tight protective film or coating.

16. The window assembly of claim 1, wherein the rotatable window, on its side pointing away from the protective pane, has a liquid-repellent and/or heat-protective coating, such as a coating with a lotus effect or a coating in the nano range.

17. The window assembly of claim 1, wherein the glass pane, on its side pointing away from the protective pane, has a liquid-repellent and/or heat-protective coating, such as a coating with a lotus effect or a coating in the nano range.

18. The window assembly of claim 1, wherein the rotary drive mechanism comprises one of a hydraulic or pneumatic motor having a drive blade element secured to the rotatable window and positioned so it can be acted upon by a hydraulic or pneumatic current, and a pneumatic or hydraulic nozzle operatively associated with said blade element and secured on the window assembly.

19. The window assembly of claim 18, wherein the drive blade element is annular and comprises multiple drive blades, and is retained coaxially relative to the rotatable window.

20. The window assembly of claim 1, further comprising means for generating a flow of air or gas out of the interior of the window assembly through the seal between the rotatable window and the glass pane.

21. The window assembly of claim 20, wherein the means for generating a flow of air or gas comprises a blade ring which is rotatable jointly with the rotatable window, and an air inlet into the interior of the window assembly.

22. The window assembly of claim 1, wherein the rotary drive mechanism is positioned laterally out of a viewing field of the rotatable window and is coupled to the rotatable window via a transmission mechanism.

23. The window assembly of claim 22, wherein the rotary drive mechanism comprises one of an electric motor, a hydraulic motor and a pneumatic motor.

24. The window assembly of claim 22, wherein the transmission mechanism has one driving wheel coupled coaxially to the rotary drive mechanism, and one driven wheel coupled coaxially to the rotatable window on its side pointing toward the protective pane, and a force transmission element that couples said driving wheel and said driven wheel, which are located in the same plane inside the window assembly, to one another.

25. The window assembly of claim 24, wherein a connection shaft couples the driven wheel to the rotatable window and is supported in the interior of the window assembly.

26. The window assembly of claim 25, wherein the connection shaft is coupled to a central connection disk that is securely connected to the rotatable window.

27. The window assembly of claim 25, wherein the connection shaft is supported, via a bearing, on a narrow retaining arm which is connected to the window assembly outside a viewing field of the rotatable window.

28. The window assembly of claim 27, wherein the retaining arm and the force transmission member are disposed so that they coincide when seen along a viewing direction.

29. The window assembly of claim 24, wherein said driving wheel and said driven wheel comprise pulleys or gear wheels, and the force transmission element comprises a belt or chain.

30. The window assembly of claim 24, wherein the rotary drive mechanism and the rotatable window are disposed on the same side of the driving and driven wheels.

31. The window assembly of claim 24, wherein the rotary drive mechanism and the rotatable window are disposed on opposite sides of the driving and driven wheels.

32. The window assembly of claim 27, wherein the retaining arm is secured to the glass pane, and the rotary drive mechanism is secured to the retaining arm.

33. The window assembly of claim 22, wherein the rotary drive mechanism is positioned laterally out of a viewing field of the rotatable window to the periphery of the window assembly.

34. The window assembly of claim 22, wherein the transmission mechanism comprises a cone wheel gear.

35. The window assembly of claim 4, wherein the receiving member comprises a body member having a wide annular rim overying a large surface area on the inside of the protective pane; and wherein a cylindrical projection of the body member provided with a male thread extend for a slight distance through the opening in the protective pane and is screwed releasably on the outside of the protective pane to an outer threaded cap which overlies a periphery of a large surface area on the outside of the protective pane.

36. The window assembly of claim 35, wherein a hydraulic or pneumatic vane or fan wheel is disposed inside the projection of said body member and is coupled to the rotatable window via a drive member, a peripheral edge of said vane or fan wheel being in operative association with a hydraulic or pneumatic nozzle retained on the body member, said drive member comprising a stepped drive shaft whose diameter increases in the direction toward the rotatable window, and two bearings rotatably supporting the drive member in the body member, said two bearings being of different radial sizes, the sizes being associated with the stepped diameter regions.

37. A safety-type viewing window assembly comprising:
a transparent glass pane having a circular opening formed therein;
a transparent protective pane coupled substantially in parallel to said glass pane and spaced therefrom to form an interior of the window assembly;
a transparent, rotatable window disposed inside said opening in said glass pane and having a diameter slightly less than the diameter of said opening in said glass pane to form a gap between the periphery of the rotatable window and said opening in the glass pane;
a rotary drive mechanism drivingly coupled to said rotatable window; and
a contactless seal positioned to close said gap.

38. A safety-type viewing window assembly comprising:
a transparent glass pane having a circular opening formed therein;
a transparent protective pane coupled substantially in parallel to said glass pane and spaced therefrom to form an interior of the window assembly;
a transparent, rotatable window disposed inside said opening in said glass pane and having a diameter slightly less than the diameter of said opening in said glass pane to form a gap between the periphery of the rotatable window and said opening in the glass pane;
a rotary drive mechanism drivingly coupled to said rotatable window; and
wherein surfaces of said rotatable window and of said glass pane that face away from said protective pane are in substantially planar alignment with one another.

39. A safety-type viewing window assembly comprising:
a transparent glass pane having a circular opening formed therein;
a transparent protective pane coupled substantially in parallel to said glass pane and spaced therefrom to form an interior of the window assembly;
a transparent, rotatable window covering said opening in said glass pane;
a rotary drive mechanism drivingly coupled to said rotatable window; and
wherein the rotary drive mechanism is disposed substantially entirely within the interior of the window assembly.
